(19) United States
(12) Patent Application Publication
(10) Pub. No.: US 2023/0016052 A1
(43) Pub. Date: Jan. 19, 2023

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yukinori II, Toyota-shi (JP); Kenji YAMAGUCHI, Miyoshi-shi (JP); Junya OGAWA, Okazaki-shi (JP); Yuki NAGANUMA, Nagoya-shi (JP); Junya YAMAMOTO, Seto-shi (JP); Yuta TONE, Nagoya-shi (JP); Naoki ISHIZUKA, Nagoya-shi (JP); Tadayuki TANAKA, Nagoya-shi (JP); Keisuke ITO, Okazaki-shi (JP); Yuka YOKOI, Miyoshi-shi (JP); Takashi HAYASHI, Nagoya-shi (JP); Naoya OKA, Nagakute-shi (JP); Yu HAMADA, Nagoya-shi (JP)

(73) Assignee: TOYOTA JIDOSHA KABUSHIKI KAISHA, Toyota-shi (JP)

(21) Appl. No.: 17/858,310

(22) Filed: Jul. 6, 2022

(30) Foreign Application Priority Data
Jul. 16, 2021 (JP) 2021-117891

(51) Int. Cl. G06Q 30/02; G06Q 50/30

(52) U.S. Cl. CPC G06Q 30/0215; G06Q 30/0208; G06Q 50/30

(57) ABSTRACT

An information processing apparatus includes a controller configured to execute processing of providing an incentive to a first user who sells or returns a first vehicle in which at least a part of a first painting film including an easily peeling layer is peeled off.

### CROSS-REFERENCE TO RELATED APPLICATION

This application claims priority to Japanese Patent Application No. 2021-117891 filed on Jul. 16, 2021, incorporated herein by reference in its entirety.

### BACKGROUND

### 1. Technical Field

The present disclosure relates to an information processing apparatus, an information processing method, and a non-transitory storage medium.

### 2. Description of Related Art

A technology in which a reward (such as money, goods, and points) is granted to a user of a vehicle when the user executes a predetermined work that can be executed even by a person who is not a vehicle mechanic is known (see, for example, Japanese Unexamined Patent Application Publication No. 2020-064552).

### SUMMARY

The present disclosure provides an effective technology for enhancing the efficiency of a service of selling or renting a vehicle.

A first aspect of the present disclosure can be regarded as an information processing apparatus. The information processing apparatus includes a controller configured to execute processing of providing an incentive to a first user who sells or returns a first vehicle in which at least a part of a first painting film including an easily peeling layer is peeled off.

In the first aspect, the processing of providing the incentive may include executing, by the controller, processes of acquiring first information on a state where the first painting film is peeled off in the first vehicle, and calculating the incentive to be provided to the first user based on the first information.

In the first aspect, the first information may include information on an area of a part from which the first painting film is peeled off in the first vehicle. The controller may be configured to calculate the incentive such that the incentive becomes higher as the area is larger.

In the first aspect, the first information may include information on a length of an elapsed time since the first painting film is peeled off. The controller may be configured to calculate the incentive such that the incentive becomes higher as the length of the elapsed time is shorter.

In the first aspect, the first information may include information on whether a peeling mark in a part from which the first painting film is peeled off is present. The controller may be configured to calculate the incentive such that the incentive becomes higher when the peeling mark is absent than when the peeling mark is present.

In the first aspect, the first information may include information on a worker who executes a work of peeling off the first painting film. The controller may be configured to calculate the incentive according to the worker.

In the first aspect, the first information may include information on a method of peeling off the first painting film. The controller may be configured to calculate the incentive according to the method.

In the first aspect, the first information may include information on a deterioration degree of an original painting in a part from which the first painting film is peeled off in the first vehicle. The controller may be configured to calculate the incentive such that the incentive becomes higher as the deterioration degree is lower.

A second aspect of the present disclosure can be regarded as an information processing method executed by a computer. The information processing method includes executing processing of providing an incentive to a first user who sells or returns a first vehicle in which at least a part of a first painting film including an easily peeling layer is peeled off.

In the second aspect, the processing of providing the incentive may include acquiring first information on a state where the first painting film is peeled off in the first vehicle, and calculating the incentive to be provided to the first user based on the first information.

In the second aspect, the first information may include information on an area of a part from which the first painting film is peeled off in the first vehicle. The processing of providing the incentive may include calculating such that the incentive becomes higher as the area is larger.

In the second aspect, the first information may include information on a length of an elapsed time since the first painting film is peeled off. The processing of providing the incentive may include calculating the incentive such that the incentive becomes higher as the length of the elapsed time is shorter.

In the second aspect, the first information may include information on whether a peeling mark in the part from which the first painting film is peeled off is present. The processing of providing the incentive may include calculating the incentive such that the incentive becomes higher when the peeling mark is absent than when the peeling mark is present.

In the second aspect, the first information may include information on a worker who executes a work of peeling off the first painting film. The processing of providing the incentive may include calculating the incentive according to the worker.

In the second aspect, the first information may include information on a method of peeling off the first painting film. The processing of providing the incentive may include calculating the incentive according to the method.

In the second aspect, the first information may include information on a deterioration degree of an original painting in the part from which the first painting film is peeled off in the first vehicle. The processing of providing the incentive may include calculating the incentive such that the incentive becomes higher as the deterioration degree is lower.

A third aspect of the present disclosure can be regarded as a non-transitory storage medium storing instructions that are executable by a computer and that cause the computer to execute functions. The functions include processing of providing an incentive to a first user who sells or returns a first vehicle in which at least a part of a first painting film including an easily peeling layer is peeled off.

In the third aspect, the processing of providing the incentive may include acquiring first information on a state where the first painting film is peeled off in the first vehicle, and calculating the incentive to be provided to the first user based on the first information.

In the third aspect, the first information may include information on an area of a part from which the first painting film is peeled off in the first vehicle. The processing of providing the incentive may include calculating the incentive such that the incentive becomes higher as the area is larger.

In the third aspect, the first information may include information on a length of an elapsed time since the first painting film is peeled off. The processing of providing the incentive may include calculating the incentive such that the incentive becomes higher as the length of the elapsed time is shorter.

With each aspect of the present disclosure, it is possible to provide an effective technology for enhancing the efficiency of a service of selling or renting a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating an overview of a used car sales system;

FIG. 2 is a diagram illustrating a first configuration example of a painting film applied on a first vehicle;

FIG. 3 is a diagram illustrating a second configuration example of the painting film applied on the first vehicle;

FIG. 4 is a diagram illustrating hardware configuration examples of a management server apparatus and a store terminal included in the used car sales system;

FIG. 5 is a block diagram illustrating a functional configuration example of the management server apparatus according to an embodiment;

FIG. 6 is a diagram used for describing a method of determining a coefficient according to the embodiment;

FIG. 7 is a flowchart illustrating a processing routine executed in the management server apparatus according to the embodiment;

FIG. 8 is a flowchart illustrating a subroutine executed in the management server apparatus according to the embodiment;

FIG. 9 is a diagram used for describing a method of determining a first correction coefficient according to a modified example 1;

FIG. 10 is a flowchart illustrating a subroutine executed in the management server apparatus according to the modified example 1;

FIG. 11 is a diagram used for describing a method of determining a second correction coefficient according to a modified example 2;

FIG. 12 is a flowchart illustrating a subroutine executed in the management server apparatus according to the modified example 2;

FIG. 13 is a diagram used for describing a method of determining a third correction coefficient according to a modified example 3; and

FIG. 14 is a flowchart illustrating a subroutine executed in the management server apparatus according to the modified example 3.

### DETAILED DESCRIPTION OF EMBODIMENTS

A technology for applying painting that can be peeled off on the body of a vehicle has been developed using a painting film (a first painting film) including an easily peeling layer. The first painting film is a peelable painting film that is applied in the form of being topcoated on an original painting applied on the body at the time of manufacturing and the like of a vehicle. In the original painting, an electrodeposition layer (an undercoat) is formed on the surface of a steel plate or the like composing the body of the vehicle, and an intermediate coat layer, a base layer, a clear layer (a topcoat), and the like are laminated on the electrodeposition layer. Since a special solution, such as a release agent, is needed to peel off the original painting, it is difficult to easily peel off the original painting. On the other hand, the first painting film is a combination of, for example, a film-like easily peeling layer formed on the original painting and a painting film (for example, a base layer and a clear layer) formed on the easily peeling layer. The first painting film can be easily peeled off by applying a force even without using a special solvent. In the first painting film, the painting film itself may be peelable (an easily peeling paint).

As described above, since the first painting film can be easily peeled off, the body color can be changed at any timing. For example, when purchasing or leasing a vehicle, an original painting having a color that is popular in a used car market and the like can be selected, and then a first painting film having a color different from that of the original painting can be applied for use of the vehicle. Then, when selling or returning the vehicle, the body color can be returned to the color of the original painting by peeling off the first painting film. As such, in a case where, for example, a color that is popular in the used car market and the like differs from a color that the user likes, it is possible to fulfil a need of the user while ensuring a resale value.

In the vehicle on which the first painting film is applied as above, since the painting film of the original painting is protected, the resale value of the vehicle can become higher than that of a vehicle on which the first painting film is not applied. As such, it is possible to easily find a next purchaser or a next borrower of the vehicle, and sell or rent the vehicle at a higher price. However, when selling or renting the vehicle to a next purchaser or a next borrower, in a case where the first painting film is not peeled off, costs and efforts needed to peel off the first painting film are incurred. On the other hand, when it is possible to motivate the user to sell or return the vehicle after peeling off the first painting film, incurred costs and efforts when selling or renting a vehicle purchased or returned from the user to a next purchaser or a next borrower can be reduced.

Therefore, in the information processing apparatus according to the present disclosure, a controller executes processing of providing an incentive to a user (a first user) who sells or returns the first vehicle in which at least a part of the first painting film (a painting film including the easily peeling layer) is peeled off. As such, the first user can receive a provision of an incentive in return for selling or returning the first vehicle after peeling off the first painting film. Thus, it is possible to motivate the first user to sell or return the first vehicle after peeling off the first painting film. Therefore, when selling or renting the first vehicle to a next purchaser or a next borrower, it is possible to reduce incurred costs and efforts. As a result, it becomes possible to enhance the efficiency of a service of selling or renting the first vehicle.

“At least a part of the first painting film is peeled off” includes a state where the entire first painting film applied on the first vehicle is peeled off and a state where only a part of the first painting film applied on the first vehicle is peeled off. However, when a proportion of a peeled part of the first painting film that is applied on the first vehicle is lower than a predetermined threshold value, the incentive does not have to be provided. “Selling the first vehicle” means, for example, that the first user sells the first vehicle to a business operator who provides services of purchasing and selling used cars, or that the first user sells the first vehicle, as a trade-in of a vehicle, to a business operator who provides a service of selling a new vehicle. “Returning the first vehicle” means that the first user returns the first vehicle to a business operator who provides a service of renting the first vehicle.

In the information processing apparatus according to the present disclosure, as the processing of providing an incentive to the first user, the controller may acquire first information on the state where the first painting film is peeled off in the first vehicle and calculate the incentive to be provided to the first user based on the first information. In this case, the incentive to be provided to the first user can be changed according to the state where the first painting film is peeled off in the first vehicle. For example, the incentive to be provided to the first user can become higher as the state where the first painting film is peeled off is closer to a state suitable for reducing incurred costs and efforts when selling or renting the first vehicle to a next purchaser or a next borrower. As a result, it is possible to motivate the first user to peel off the first painting film such that the state where the first painting film is peeled off becomes the state suitable for reducing incurred costs and efforts when selling or renting the first vehicle to a next purchaser or a next borrower.

Here, the first information may include information on an area of the part from which the first painting film is peeled off in the first vehicle. In that case, the controller may calculate the incentive such that it becomes higher as the area of the part from which the first painting film is peeled off is larger. As such, it is possible to motivate the first user to peel off the first painting film such that the area of the part from which the first painting film is peeled off becomes larger. As a result, it is possible to reduce costs and efforts when selling or renting the first vehicle to a next purchaser or a next borrower.

Further, the appearance and the like of the original painting in the part from which the first painting film is peeled off may deteriorate more as a length of an elapsed time since the first painting film has been peeled off is longer. Here, the first information may include information on the length of the elapsed time since the first painting film has been peeled off. In that case, the controller may calculate the incentive such that it becomes higher as the length of the elapsed time since the first painting film has been peeled off is shorter. As such, it is possible to motivate the first user to sell or return the first vehicle before the length of the elapsed time since the first painting film has been peeled off becomes long. In other words, it is possible to motivate the first user to peel off the first painting film immediately before selling or returning the first vehicle. As a result, it is easy to sell or return the first vehicle before the appearance of the original painting in the part from which the first painting film is peeled off deteriorates.

Further, the first information may include information on whether a peeling mark in the part from which the first painting film is peeled off is present. In that case, the controller may calculate the incentive such that it becomes higher when a peeling mark in the part from which the first painting film is peeled off is absent than when a peeling mark is present. As such, it is possible to motivate the first user to peel off the first painting film such that no peeling mark is left. As a result, it is possible to reduce costs and efforts needed to remove a peeling mark of the first painting film.

Further, the first information may include information on a worker who has executed the work of peeling off the first painting film. In that case, the controller may calculate the incentive according to the worker. For example, the controller may calculate the incentive such that it becomes higher when the worker is a person (hereinafter, sometimes referred to as a “first worker”) who provides the service of peeling off the first painting film as a job, such as an employee of a maintenance shop, a car dealer, or the like than when the worker is a person (for example, the first user) other than the first worker. As such, it is possible to motivate the first user to request the first worker or the like to execute the work of peeling off the first painting film. As a result, it is possible to more reliably reduce a possibility of damaging the original painting or leaving a peeling mark when the first painting film is peeled off.

Further, the first information may include information on a method of peeling off the first painting film. In that case, the controller may calculate the incentive according to the method of peeling off the first painting film. For example, the controller may calculate the incentive such that it becomes higher when the method of peeling off the first painting film in the first vehicle is a method (hereinafter, sometimes referred to as a “first method”) in which the original painting is not easily damaged and a peeling mark is not easily left, such as a method of peeling off the first painting film by spraying a high-pressure water stream on the first vehicle, than when the method is a method (for example, a method of manually peeling off the first painting film) other than the first method. As such, it is possible to motivate the first user to peel off the first painting film by the first method. As a result, it is possible to more reliably reduce a possibility of damaging the original painting or leaving a peeling mark when the first painting film is peeled off.

Further, the first information may include information on a deterioration degree of the original painting in the part from which the first painting film is peeled off in the first vehicle. In that case, the controller may calculate the incentive such that it becomes higher as the deterioration degree of the original painting in the part from which the first painting film is peeled off is lower. As such, it is possible to motivate the first user to handle the first vehicle such that the original painting in the part from which the first painting film is peeled off does not deteriorate, or to sell the first vehicle before the deterioration degree of the original painting in the part from which the first painting film is peeled off becomes high. As a result, it is possible to increase the resale value of the first vehicle.

### EMBODIMENTS

Hereinafter, specific embodiments of the present disclosure will be described with reference to drawings. Unless otherwise specified, the configurations described in the present embodiments are not intended to limit the technical scope of the present disclosure only thereto.

In the present embodiment, an example where the information processing apparatus according to the present disclosure is applied to a system (hereinafter, sometimes referred to as a “used car sales system”) that provides services of purchasing and selling used cars will be described. The information processing apparatus according to the present disclosure can also be applied to a system that provides a service of renting a vehicle (a lease service).

### Overview of System

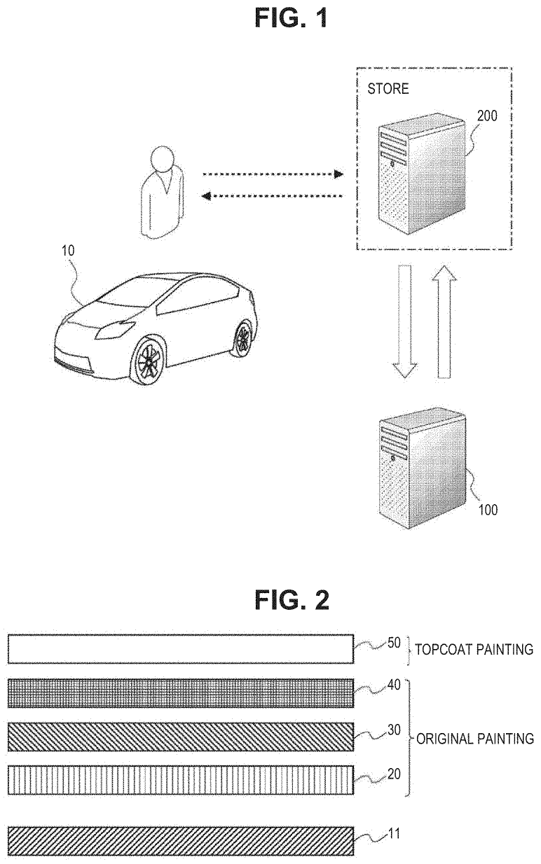

FIG. 1 is a diagram illustrating an overview of the used car sales system to which the information processing apparatus according to the present disclosure is applied. The used car sales system in the present embodiment includes a management server apparatus 100 that manages purchasing and selling used cars, and a store terminal 200 used in a store in which used cars are purchased and sold. In the example illustrated in FIG. 1, only one store terminal 200 is illustrated, but when there is a plurality of stores under a control of the management server apparatus 100, the same number of store terminals 200 as the number of stores may be included.

The management server apparatus 100 manages purchasing and selling used cars executed in a store, and is an example of the “information processing apparatus” according to the present disclosure. The management server apparatus 100 is operated by a business operator who provides the services of purchasing and selling used cars.

The management server apparatus 100 of the present embodiment executes various processes for providing an incentive to the first user who is a seller of a vehicle (a first vehicle 10) when the first vehicle 10 in which a topcoat painting is peeled off is purchased in the store. The topcoat painting is a peelable painting film that is applied in the form of being topcoated on the original painting applied on the body at the time of manufacturing and the like of the first vehicle 10, and is an example of the “first painting film” according to the present disclosure. Details of the topcoat painting will be described below.

When purchasing the first vehicle 10 in which the topcoat painting is peeled off in the store, the management server apparatus 100 calculates an incentive based on the first information (information on a state where the topcoat painting is peeled off in the first vehicle 10) provided from the store terminal 200 described below, and requests the store terminal 200 to provide the calculated incentive to the first user (hereinafter, sometimes referred to as a “provision request”). In the present embodiment, the state where “the topcoat painting is peeled off” is not limited to a state where the entire topcoat painting applied on the first vehicle 10 is peeled off and also includes a state where a part of the topcoat painting applied on the first vehicle 10 is peeled off.

The store terminal 200 is used by an employee of a store in which a used car is purchased from and sold to a user. In the present embodiment, when purchasing the first vehicle 10, the store terminal 200 receives an input of the first information and provides the received first information to the management server apparatus 100. The input of the first information is executed by the employee of the store. Further, upon receiving the provision request from the management server apparatus 100, the store terminal 200 presents the provision request to the employee of the store. The employee who receives such a presentation can carry out procedures for providing an incentive to the first user according to the provision request.

Examples of the incentive in the present embodiment include increasing a purchase price of the first vehicle 10, granting points that can be used at the store, discounting when purchasing a used car at the store, or giving cash. However, the examples are not limited thereto and the incentive may be anything as long as it is beneficial to the first user.

Topcoat Painting

Here, the painting applied on the first vehicle 10 will be described. FIG. 2 is a diagram illustrating a schematic configuration of the painting film applied on the first vehicle 10. As illustrated in FIG. 2, the original painting is applied on the surface of a steel plate 11 composing the body of the first vehicle 10, and the topcoat painting is applied on the original painting. The original painting includes an intermediate coat layer 20 formed on the surface of the steel plate 11, a base layer 30 formed on the intermediate coat layer 20, and a clear layer (the topcoat) 40 formed on the base layer 30. The steel plate 11 is undercoated with an electrodeposition layer. Further, when a member composing the body of the first vehicle 10 is made of resin, a primer layer may be formed instead of the intermediate coat layer 20 of the original painting. Since a special solution, such as a release agent, is needed to peel off the original painting formed as above, it is difficult to easily peel off the original painting.

Next, the topcoat painting includes a peeling layer 50 formed on the original painting (on the clear layer 40). The peeling layer 50 is a layer of an easily peeling paint and has a property of being easily peeled off by applying a force. The peeling layer 50 exemplified in FIG. 2 is an example of the “painting film that includes the easily peeling layer (the first painting film)” according to the present disclosure. Such a peeling layer 50 is formed by applying the easily peeling paint on the original painting using, for example, a spraying method. The easily peeling paint is a paint that includes, for example, xylene, ethylbenzene, an antioxidant, methyl ethyl ketone, a silica reactant, titanium oxide (nanoparticles), and an organic solvent. A clear layer may be formed on the peeling layer 50.

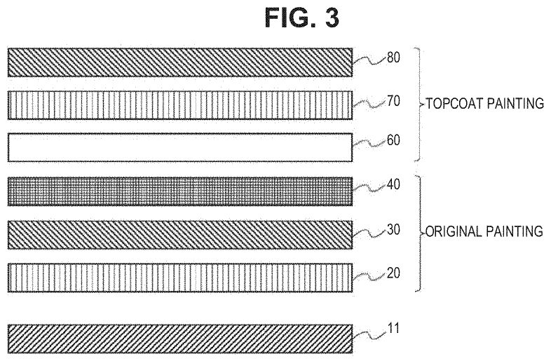

The topcoat painting illustrated in FIG. 2 has a peeling property in the paint itself, but a composition of the topcoat painting is not limited to the example of FIG. 2, and any painting film having an easy peeling property may be used. For example, as illustrated in FIG. 3, a peeling layer 60 may be formed on the clear layer 40 of the original painting, and a base layer 70 and a clear layer 80 may be formed on the peeling layer 60. The peeling layer 60 illustrated in FIG. 3 is formed without coloring using the same material as that of the peeling layer 50 in FIG. 2. In that case, the peeling layer 60 is one example of the “easily peeling layer” according to the present disclosure, and the topcoat painting including the peeling layer 60, the base layer 70, and the clear layer 80 is one example of the “the painting film that includes the easily peeling layer (the first painting film)” according to the present disclosure. The topcoat painting illustrated in FIG. 3 can be easily peeled off from the original painting by applying a force to the peeling layer 60.

Using the topcoat painting, it is easy to change the body color of the first vehicle 10 to a color different from that of the original painting. Further, by peeling off the topcoat painting, it is also easy to return the body color of the first vehicle 10 to the color of the original painting. Therefore, when purchasing the first vehicle 10, an original painting having a color that is popular in the used car market and the like can be selected, and then a topcoat painting having a color different from that of the original painting can be applied for use of the first vehicle 10. Then, when selling the first vehicle 10 in the used car market and the like, by peeling off the topcoat painting, it is possible to return to the original painting having a color that is popular in the used car market and the like, and thus it is easier to attract purchasers to the first vehicle 10 and it is also possible to sell the first vehicle 10 at a high price. Further, by purchasing, from the user, a vehicle in the state where the topcoat painting is peeled off, the business operator who provides the services of purchasing and selling used cars can reduce incurred costs and efforts needed to peel off the topcoat painting.

### System Configuration

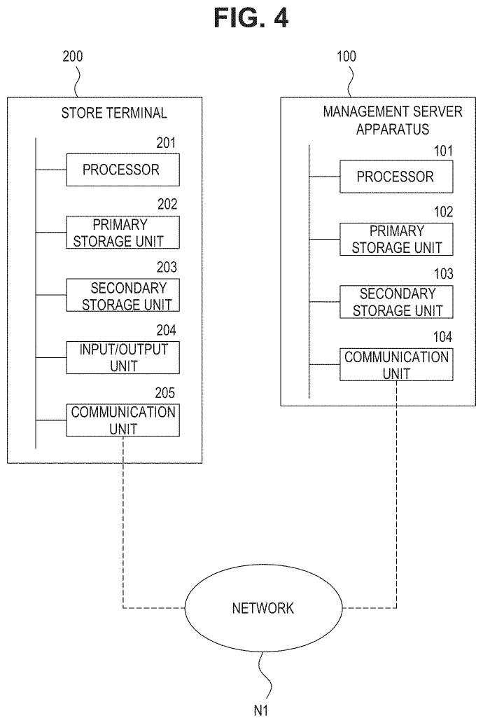

FIG. 4 is a diagram illustrating hardware configuration examples of the management server apparatus 100 and the store terminal 200 included in the used car sales system according to the present embodiment.

The management server apparatus 100 is a computer installed in a business office or the like that oversees a store. As illustrated in FIG. 4, the management server apparatus 100 includes a processor 101, a primary storage unit 102, a secondary storage unit 103, and a communication unit 104. The processor 101, the primary storage unit 102, the secondary storage unit 103, and the communication unit 104 are connected to each other via buses. The hardware configuration of the management server apparatus 100 is not limited to the example illustrated in FIG. 4, and components may be omitted, replaced, or added as appropriate.

The processor 101 controls the management server apparatus 100 by executing arithmetic processing of various pieces of information. Such a processor 101 is composed of, for example, a central processing unit (CPU) or a digital signal processor (DSP).

The primary storage unit 102 is a storage device used as a recording area into which a program stored in the secondary storage unit 103 is loaded, or as a buffer that temporarily stores a calculation result or the like of the processor 101. Such a primary storage unit 102 includes, for example, a semiconductor memory, such as a read-only memory (ROM) and a random access memory (RAM).

The secondary storage unit 103 stores, for example, a program to be executed by the processor 101, and data used when the processor 101 executes the program. Such a secondary storage unit 103 includes, for example, an erasable programmable ROM (EPROM) or a hard disk drive (HDD). The secondary storage unit 103 may include a removable medium. The removable medium may be, for example, a disc recording medium, such as a compact disc (CD) or a digital versatile disc (DVD), or may be a universal serial bus (USB) memory. In addition to an operating system (OS), the program stored in the secondary storage unit 103 includes an application program related to the provision of an incentive. A part or all of the information stored in the secondary storage unit 103 may be stored in the primary storage unit 102.

The communication unit 104 is a communication interface used for connecting the management server apparatus 100 to a network N1. The communication unit 104 is connected to the network N1 using, for example, a communication network, such as a local area network (LAN). The communication unit 104 may be connected to the network N1 using a wireless communication network, such as Wi-Fi®. The communication unit 104 communicates with other apparatuses (for example, a store terminal 200) via the network N1.

The network N1 may be, for example, a wide area network (WAN), which is a global public communication network, such as the Internet, or other communication networks. The network N1 may include a telephone communication network, such as a mobile phone, or a wireless communication network, such as Wi-Fit.

The store terminal 200 is a computer used by the employee of the store in which a used car is purchased from and sold to a user. The store terminal 200 may be a stationary computer installed in the store, or a tablet computer that can be carried by the employee. As illustrated in FIG. 4, the store terminal 200 includes a processor 201, a primary storage unit 202, a secondary storage unit 203, an input/output unit 204, and a communication unit 205. The processor 201, the primary storage unit 202, the secondary storage unit 203, the input/output unit 204, and the communication unit 205 are connected to each other via buses. The hardware configuration of the store terminal 200 is not limited to the example illustrated in FIG. 4, and components may be omitted, replaced, or added as appropriate.

Here, since the processor 201, the primary storage unit 202, the secondary storage unit 203, and the communication unit 205 are the same as the processor 101, the primary storage unit 102, the secondary storage unit 103, and the communication unit 104 of the management server apparatus 100, description thereof will be omitted. However, the communication unit 205 may be configured to be connected to the network N1 using a mobile communication service, such as Fifth Generation (5G) or Long-Term Evolution (LTE).

The input/output unit 204 receives an input operation executed by the employee of the store and presents information to the employee. The input/output unit 204 includes, for example, a keyboard and a control circuit thereof, and a liquid crystal display and a control circuit thereof. Instead of the keyboard and the liquid crystal display, the input/output unit 204 may include a touch panel display.

The store terminal 200 configured as above has a function of implementing interaction with the employee. For example, the store terminal 200 implements a function of receiving the input of the first information by the employee, a function of providing the received first information to the management server apparatus 100, and a function of presenting a provision request received from the management server apparatus 100 to the employee. These functions are implemented by a browser operating in the store terminal 200 or an application program stored in the secondary storage unit 203. A part or all of the functions implemented in the store terminal 200 may be implemented by a hardware circuit, such as an application-specific integrated circuit (ASIC) or a field-programmable gate array (FPGA).

Functional Configuration of Management Server Apparatus

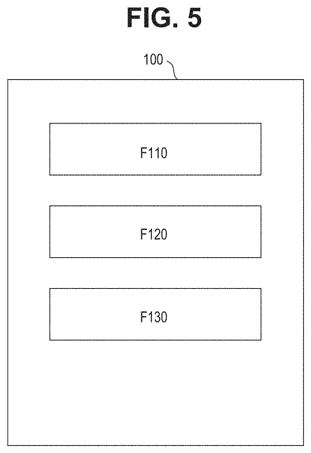

Here, a functional configuration of the management server apparatus 100 will be described with reference to FIG. 5. The management server apparatus 100 in the present embodiment may be configured to be capable of implementing a web server used for executing interaction with the store terminal 200. In that case, by accessing the web server through the browser, the store terminal 200 can conclude a purchasing contract for the first vehicle 10 of the first user, provide the first information to the management server apparatus 100, receive the provision request from the management server apparatus 100, and the like. The management server apparatus 100 may provide the same services as above using equipment other than the web server. For example, the management server apparatus 100 may execute processing of implementing interaction with the store terminal 200 using a predetermined protocol and the application program installed in the store terminal 200.

As illustrated in FIG. 5, the management server apparatus 100 that implements the above functions includes, as functional components, an acquisition unit F110, a calculation unit F120, and a request unit F130. Functions of the acquisition unit F110, the calculation unit F120, and the request unit F130 are implemented when the processor 101 executes a program stored in the secondary storage unit 103. The processor 101 that implements the functions of the above functional components is an example of the “controller” according to the present disclosure. A part or all of the functions of the acquisition unit F110, the calculation unit F120, and the request unit F130 may be implemented by a hardware circuit, such as an ASIC or an FPGA.

The acquisition unit F110 is one of the functional components used for implementing the above-described web server, and executes interaction with the store terminal 200. For example, when the store terminal 200 accesses, through the browser, a predetermined webpage (for example, a web page used for inputting information necessary for a purchasing contract of the first vehicle 10 or a webpage used for inputting information indicating that a purchasing contract of the first vehicle 10 has been concluded), the acquisition unit F110 causes the store terminal 200 to display, on the browser thereof, an input screen of the first information. As described above, the first information is information on the state where the topcoat painting is peeled off in the first vehicle 10. When the first information is input on the input screen, the acquisition unit F110 acquires the input first information. The first information acquired by the acquisition unit F110 is transferred from the acquisition unit F110 to the calculation unit F120.

The calculation unit F120 calculates an incentive to be provided to the first user based on the first information. As the first information, the calculation unit F120 of the present embodiment uses the information on the area of the part from which the topcoat painting is peeled off in the first vehicle 10. Specifically, as the first information, the calculation unit F120 uses a proportion of the area of the part from which the topcoat painting is peeled off to the area on which the topcoat painting is applied (hereinafter, sometimes referred to as a “first proportion”). In that case, the calculation unit F120 calculates the incentive by a method in which the incentive to be provided to the first user becomes higher as the first proportion is higher.

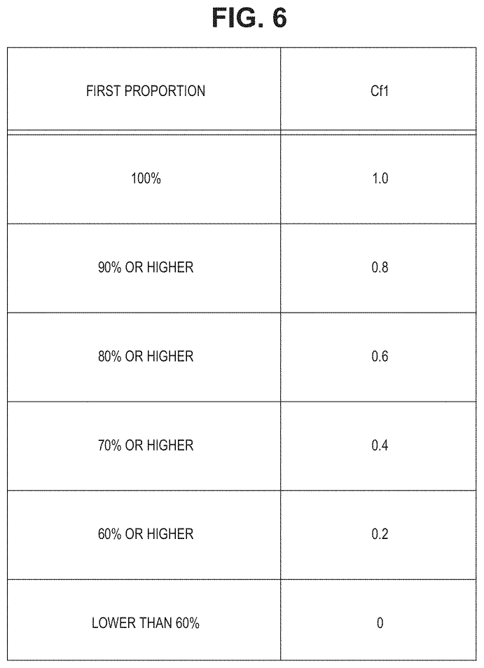

For example, the calculation unit F120 first determines a coefficient Cf1 based on a correspondence relationship as illustrated in FIG. 6. As illustrated in FIG. 6, the coefficient Cf1 is a positive number of 1.0 or smaller, and is set such that its value becomes higher as the first proportion is higher. In an example illustrated in FIG. 6, when the first proportion is lower than 60%, the coefficient Cf1 is set to “0”. Further, when the first proportion is 60% or higher, the coefficient Cf1 is set to become higher as the first proportion is higher, and when the first proportion is 100% (that is, the part from which the topcoat painting is not peeled off is absent), the coefficient Cf1 is set to become the maximum of 1.0. The correspondence relationship as illustrated in FIG. 6 may be stored in the secondary storage unit 103 in the form of a map, or may be stored in the secondary storage unit 103 in the form of a calculation model. Further, numerical values of the first proportion and values of the coefficient Cf1 illustrated in FIG. 6 are merely examples and are not limited to the examples of FIG. 6.

When the coefficient Cf1 is determined by the method as above, the calculation unit F120 calculates the incentive to be provided to the first user by multiplying a reference value Icdef of the incentive by the coefficient Cf1. The reference value Icdef is an upper limit value of the incentive, and corresponds to a value (an amount of money, a point, or the like) of the incentive to be provided when the part from which the topcoat painting is not peeled off is absent. When the first proportion is 60% or higher, the incentive calculated in this manner becomes higher as the first proportion is higher. On the other hand, when the first proportion is lower than 60%, the incentive to be provided to the first user becomes “0” (the incentive is not provided to the first user). The incentive calculated by the calculation unit F120 is transferred from the calculation unit F120 to the request unit F130.

The calculation method of the incentive is not limited to the above method, and any method may be used as long as it is a calculation method in which the incentive becomes higher as the area of the part from which the topcoat painting is peeled off in the first vehicle 10 is larger. For example, the incentive may be calculated by a method in which the incentive becomes higher as the absolute amount of the area of the part from which the topcoat painting is peeled off in the first vehicle 10 is larger.

Here, returning to FIG. 5, in the same manner as the acquisition unit F110, the request unit F130 is one of the functional components used for implementing the above-described web server, and executes interaction with the store terminal 200. For example, the request unit F130 causes the store terminal 200 to display, on the browser thereof, the provision request. The provision request at that time includes, for example, the incentive calculated by the calculation unit F120 and a message prompting the employee of the store to provide the incentive to the first user. The employee who sees such a provision request can provide the incentive calculated by the calculation unit F120 to the first user.

The functional configuration of the management server apparatus 100 is not limited to the example illustrated in FIG. 5, and the functional components can be omitted, replaced, or added as appropriate.

Flow of Processing

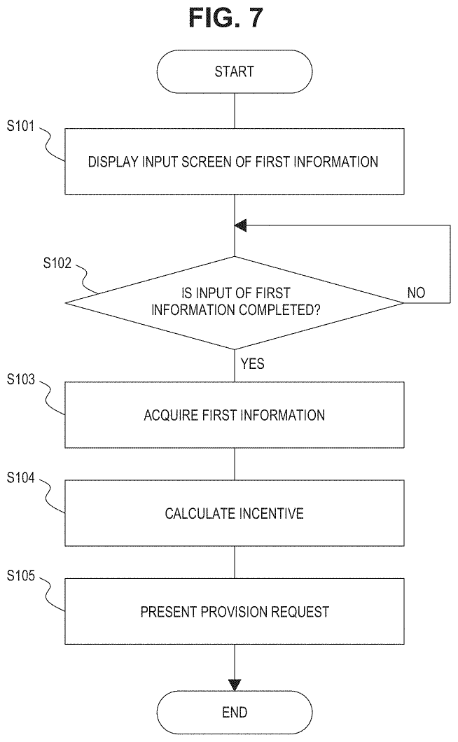

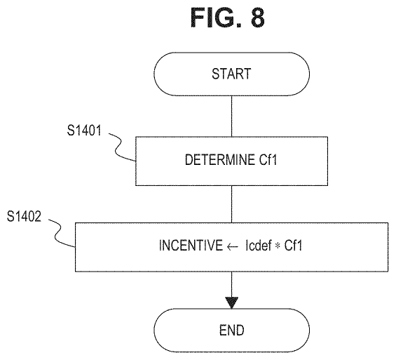

Flows of processing executed in the management server apparatus 100 in the present embodiment will be described with reference to FIGS. 7 and 8. FIG. 7 is a flowchart illustrating a processing routine executed when the store terminal 200 accesses the above-described predetermined web page through the browser. FIG. 8 is a flowchart illustrating a subroutine executed in step S104 in FIG. 7. A subject that executes the processing illustrated in FIGS. 7 and 8 is the processor 101 of the management server apparatus 100, but here, the description will be made by setting the functional component of the management server apparatus 100 as the subject.

When the store terminal 200 accesses the above-described predetermined web page through the browser, as illustrated in FIG. 7, the acquisition unit F110 causes the store terminal 200 to display, on the browser thereof, the input screen of the first information (step S101). Upon ending the execution of the process of step S101, the acquisition unit F110 executes a process of step S102.

In step S102, the acquisition unit F110 determines whether the input of the first information is completed on the input screen of the first information. When the input of the first information on the input screen of the first information is not completed (a negative determination in step S102), the acquisition unit F110 stands by until the input of the first information is completed. On the other hand, when the input of the first information on the input screen of the first information is completed (a positive determination in step S102), the acquisition unit F110 executes a process of step S103.

In step S103, the acquisition unit F110 acquires the first information that is input on the input screen of the first information. The first information acquired by the acquisition unit F110 is transferred from the acquisition unit F110 to the calculation unit F120. Upon receiving the first information, the calculation unit F120 executes a process of step S104.

In step S104, the calculation unit F120 calculates the incentive to be provided to the first user based on the first information received from the acquisition unit F110. At that time, the calculation unit F120 calculates the incentive to be provided to the first user according to the subroutine of FIG. 8.

In FIG. 8, the calculation unit F120 determines the coefficient Cf1 based on the first information received from the acquisition unit F1110 (step S1401). For example, the calculation unit F120 determines the coefficient Cf1 based on the first information and the above-described correspondence relationship illustrated in FIG. 6. Upon ending the execution of the process of step S1401, the calculation unit F120 executes a process of step S1402.

In step S1402, the calculation unit F120 calculates the incentive to be provided to the first user by multiplying the reference value Icdef of the incentive by the coefficient Cf1 determined in step S1401. When the calculation unit F120 ends the execution of the process of step S1402, the execution of the subroutine of FIG. 8 ends.

Here, returning to the processing routine of FIG. 7, the calculation unit F120 transfers the incentive calculated in step S104 (steps S1401 and S1402) to the request unit F130. Upon receiving the incentive calculated by the calculation unit F120, the request unit F130 executes a process of step S105.

In step S105, the request unit F130 presents the provision request to the employee of the store. Specifically, the request unit F130 causes the store terminal 200 to display, on the browser thereof, the provision request. As such, the employee who sees the provision request displayed on the store terminal 200 can provide, to the first user, the incentive calculated in the management server apparatus 100.

When the request unit F130 ends the execution of the process of step S105, the execution of the processing routine of FIG. 7 ends.

### Advantageous Effect of Embodiments

With the above-described embodiment, when the first proportion is high (for example, 60% or higher), the incentive is provided to the first user who sells the first vehicle 10. In other words, when selling the first vehicle 10, the first user can receive the incentive in return for peeling off the first painting film such that the first proportion becomes higher. As such, it is possible to motivate the first user to peel off the first painting film such that the first proportion becomes higher. Further, since the incentive that the first user can receive becomes higher as the first proportion is higher, it is also possible to prompt the first user to peel off the first painting film such that the first proportion becomes even higher.

Therefore, the business operator who provides services of purchasing and selling used cars can purchase, from the first user, the first vehicle 10 in a state where the area of the part from which the topcoat painting is peeled off is larger. As a result, the business operator who provides the services of purchasing and selling used cars can reduce costs and efforts needed to peel off the topcoat painting in the first vehicle 10.

### Modified Example 1

In the above-described embodiment, the example where only the first proportion (the proportion of the area of the part from which the topcoat painting is peeled off to the area on which the topcoat painting is applied) is used as the first information is described. However, in addition to the first proportion, the length of the elapsed time since the topcoat painting has been peeled off may be used.

Here, the appearance of the original painting in the part from which the topcoat painting is peeled off may deteriorate more (for example, damage or a faded color) as the length of the elapsed time since the topcoat painting has been peeled off is longer. On the other hand, when the first user can be enabled to sell the first vehicle 10 before the length of the elapsed time since the topcoat painting has been peeled off becomes long, the business operator who provides the services of purchasing and selling used cars can purchase the first vehicle 10 from the first user before the appearance of the original painting deteriorates.

Therefore, in this modified example, the incentive is calculated by a method in which the incentive to be provided to the first user becomes higher as the first proportion is higher and the length of the elapsed time since the topcoat painting has been peeled off is shorter.

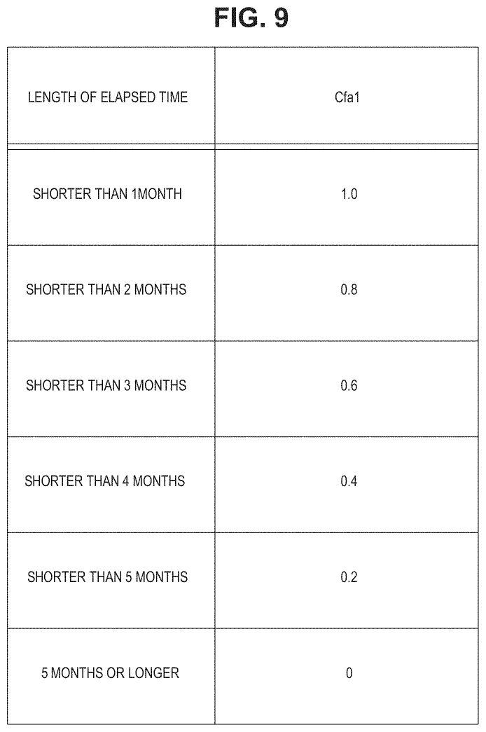

In addition to determining the coefficient Cf1 by the same method as that of the above-described embodiment, the calculation unit F120 of this modified example determines a first correction coefficient Cfa1 based on a correspondence relationship as illustrated in FIG. 9. As illustrated in FIG. 9, the first correction coefficient Cfa1 is a positive number of 1.0 or smaller, and is set such that its value becomes higher as the length of the elapsed time since the topcoat painting has been peeled off is shorter. For example, when the length of the elapsed time since the topcoat painting has been peeled off is 5 months or longer, the first correction coefficient Cfa1 is set to “0”. On the other hand, when the length of the elapsed time since the topcoat painting has been peeled off is shorter than 5 months, the first correction coefficient Cfa1 is set to become higher as the length of the elapsed time is shorter, and when the length of the elapsed time is shorter than 1 month, the first correction coefficient Cfa1 is set to become the maximum of “1.0”. The correspondence relationship as illustrated in FIG. 9 may be stored in the secondary storage unit 103 in the form of a map, or may be stored in the secondary storage unit 103 in the form of a calculation model. Further, numerical values of the length of the time and values of the first correction coefficient Cfa1 illustrated in FIG. 9 are merely examples and are not limited to the examples of FIG. 9.

When the coefficient Cf1 and the first correction coefficient Cfa1 are determined by the methods as above, the calculation unit F120 calculates the incentive to be provided to the first user by multiplying the reference value Icdef of the incentive by the coefficient Cf1 and the first correction coefficient Cfa1. The value of the incentive calculated in this manner becomes higher as the first proportion is higher and the length of the elapsed time since the topcoat painting has been peeled off is shorter.

Flow of Processing

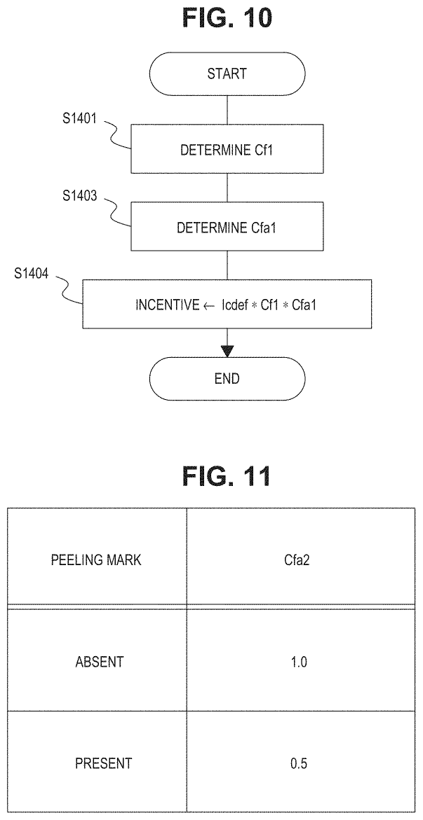

Here, a flow of processing executed in the management server apparatus 100 in this modified example will be described with reference to FIG. 10. FIG. 10 is a flowchart illustrating a subroutine that is executed instead of the above-described subroutine of FIG. 8 in the above-described step S104 in FIG. 7. In FIG. 10, processes the same as those in the above-described FIG. 8 are denoted by the same reference signs.

In FIG. 10, upon ending the execution of the process of step S1401, the calculation unit F120 executes a process of step S1403. In step S1403, the calculation unit F120 determines the first correction coefficient Cfa1. Specifically, the calculation unit F120 determines the first correction coefficient Cfa1 based on the length of the elapsed time since the topcoat painting has been peeled off and the above-described correspondence relationship illustrated in FIG. 9. As such, the first correction coefficient Cfa1 is determined such that its value becomes higher as the length of the elapsed time since the topcoat painting has been peeled off is shorter. Further, when the length of the elapsed time since the topcoat painting has been peeled off is excessively long (for example, in the example illustrated in FIG. 9, 5 months or longer), the first correction coefficient Cfa1 is determined to be “0”. Upon ending the execution of the process of step S1403, the calculation unit F120 executes a process of step S1404.

In step S1404, the calculation unit F120 calculates the incentive to be provided to the first user by multiplying the reference value Icdef of the incentive by the coefficient Cf1 determined in step S1401 and the first correction coefficient Cfa1 determined in step S1403. In this modified example, when the first proportion is lower than 60% and/or when the length of the elapsed time since the topcoat painting has been peeled off is 5 months or longer, the incentive calculated by the calculation unit F120 becomes “0”. On the other hand, when the first proportion is 60% or higher and the length of the elapsed time since the topcoat painting has been peeled off is shorter than 5 months, the incentive calculated by the calculation unit F120 becomes higher as the first proportion is higher and the length of the elapsed time since the topcoat painting has been peeled off is shorter. When the calculation unit F120 ends the execution of the process of step S1404, the execution of the subroutine of FIG. 10 ends.

With this modified example, the incentive to be provided to the first user who sells the first vehicle 10 becomes higher as the first proportion is higher and the length of the elapsed time since the topcoat painting has been peeled off is shorter. As such, it is possible to motivate the first user to peel off the topcoat painting such that the first proportion becomes even higher and to sell the first vehicle 10 before the length of the elapsed time since the topcoat painting has been peeled off becomes long (to peel off the topcoat painting immediately before selling the first vehicle 10). As a result, the business operator who provides the services of purchasing and selling used cars can reduce costs and efforts needed to peel off the topcoat painting and purchase, from the first user, the first vehicle 10 in a state where the resale value thereof is even higher.

Since the length of the elapsed time since the topcoat painting has been peeled off is included in the first information, the store needs to determine the length of the elapsed time. The length of the elapsed time may be determined based on a declaration from the first user, a declaration from a worker who has executed the work of peeling off the topcoat painting, or an image captured by a camera (for example, a camera of a drive recorder) mounted on the first vehicle 10.

### Modified Example 2

In the above-described modified example 1, the example where the first proportion and the length of the elapsed time since the topcoat painting has been peeled off are used as the first information is described. However, the first proportion and information on the presence/absence of a peeling mark in the part from which the topcoat painting is peeled off may be used. In other words, in the above-described modified example 1, the information on the presence/absence of a peeling mark in the part from which the topcoat painting is peeled off may be used instead of the length of the elapsed time since the topcoat painting has been peeled off.

Here, when a peeling mark in the part from which the topcoat painting is peeled off is left, the business operator who provides the services of purchasing and selling used cars needs to execute the work of removing the peeling mark. On the other hand, when it is possible to prompt the first user to peel off the topcoat painting such that no peeling mark is left, the business operator who provides the services of purchasing and selling used cars does not need to incur costs and efforts needed to remove the peeling mark.

Therefore, in this modified example, the incentive is calculated by a method in which the incentive to be provided to the first user becomes higher as the first proportion is higher, and the incentive to be provided to the first user becomes higher when a peeling mark in the part from which the topcoat painting is peeled off is absent than when a peeling mark is present.

In addition to determining the coefficient Cf1 by the same method as that of the above-described embodiment, the calculation unit F120 of this modified example determines a second correction coefficient Cfa2 based on a correspondence relationship as illustrated in FIG. 11. As illustrated in FIG. 11, the second correction coefficient Cfa2 is a positive number of 1.0 or smaller, and is set such that its value becomes higher when a peeling mark in the part from which the topcoat painting is peeled off is absent than when a peeling mark is present. In the example illustrated in FIG. 11, the second correction coefficient Cfa2 is set only according to the presence/absence of a peeling mark in the part from which the topcoat painting is peeled off, but the second correction coefficient Cfa2 may also be set by considering the number of peeling marks. In other words, when peeling marks are present, the value of the second correction coefficient Cfa2 may become higher as the number of peeling marks is smaller.

When the coefficient Cf1 and the second correction coefficient Cfa2 are determined by the methods as above, the calculation unit F120 calculates the incentive to be provided to the first user by multiplying the reference value Icdef of the incentive by the coefficient Cf1 and the second correction coefficient Cfa2. The value of the incentive calculated in this manner becomes higher as the first proportion is higher, and the value becomes higher when a peeling mark in the part from which the topcoat painting is peeled off is absent than when a peeling mark is present.

Flow of Processing

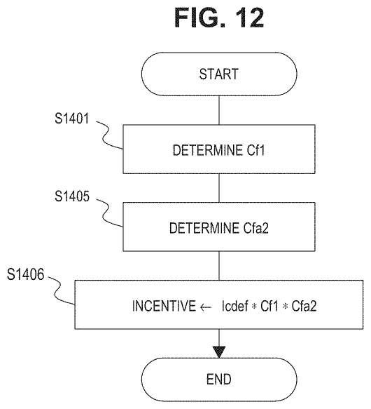

Here, a flow of processing executed in the management server apparatus 100 in this modified example will be described with reference to FIG. 12. FIG. 12 is a flowchart illustrating a subroutine that is executed instead of the above-described subroutine of FIG. 8 in the above-described step S104 in FIG. 7. In FIG. 12, processes the same as those in the above-described FIG. 8 are denoted by the same reference signs.

In FIG. 12, upon ending the execution of the process of step S1401, the calculation unit F120 executes a process of step S1405. In step S1405, the calculation unit F120 determines the second correction coefficient Cfa2. Specifically, the calculation unit F120 determines the second correction coefficient Cfa2 based on the presence/absence of a peeling mark in the part from which the topcoat painting is peeled off and the above-described correspondence relationship illustrated in FIG. 11. As such, the second correction coefficient Cfa2 is determined such that its value becomes higher when a peeling mark in the part from which the topcoat painting is peeled off is absent than when a peeling mark is present. Upon ending the execution of the process of step S1405, the calculation unit F120 executes a process of step S1406.

In step S1406, the calculation unit F120 calculates the incentive to be provided to the first user by multiplying the reference value Icdef of the incentive by the coefficient Cf1 determined in step S1401 and the second correction coefficient Cfa2 determined in step S1405. In this modified example, when the first proportion is lower than 60%, the incentive calculated by the calculation unit F120 becomes “0”. On the other hand, when the first proportion is 60% or higher, the value of the incentive calculated by the calculation unit F120 becomes higher as the first proportion is higher, and the value becomes higher when a peeling mark is absent than when a peeling mark is present. When the calculation unit F120 ends the execution of the process of step S1406, the execution of the subroutine of FIG. 12 ends.

With this modified example, the incentive to be provided to the first user who sells the first vehicle 10 becomes higher as the first proportion is higher, and the incentive to be provided to the first user who sells the first vehicle 10 becomes higher when a peeling mark is absent than when a peeling mark is present. As such, it is possible to motivate the first user to peel off the topcoat painting such that the first proportion becomes even higher, and to peel off the topcoat painting such that no peeling mark is left. As a result, the business operator who provides the services of purchasing and selling used cars can reduce costs and efforts needed to peel off the topcoat painting or needed to remove a peeling mark in the first vehicle 10.

### Modified Example 3

In the above-described modified example 1, the example where the first proportion and the length of the elapsed time since the topcoat painting has been peeled off are used as the first information is described. However, the first proportion and the deterioration degree of the original painting in the part from which the topcoat painting is peeled off may be used. In other words, in the above-described modified example 1, the deterioration degree of the original painting in the part from which the topcoat painting is peeled off may be used instead of the length of the elapsed time since the topcoat painting has been peeled off.

Here, when the deterioration degree of the original painting in the part from which the topcoat painting is peeled off is higher, the resale value of the first vehicle 10 may become lower. On the other hand, when it is possible to prompt the first user to sell the first vehicle 10 before the deterioration degree of the original painting in the part from which the topcoat painting is peeled off becomes higher or to handle the first vehicle 10 such that the deterioration degree of the original painting in the part from which the topcoat painting is peeled off does not become higher, the business operator who provides the services of purchasing and selling used cars can purchase the first vehicle 10 in a state where the deterioration degree of the original painting in the part from which the topcoat painting is peeled off is low.

Therefore, in this modified example, the incentive is calculated by a method in which the incentive to be provided to the first user becomes higher as the first proportion is higher and as the deterioration degree of the original painting in the part from which the topcoat painting is peeled off is lower.

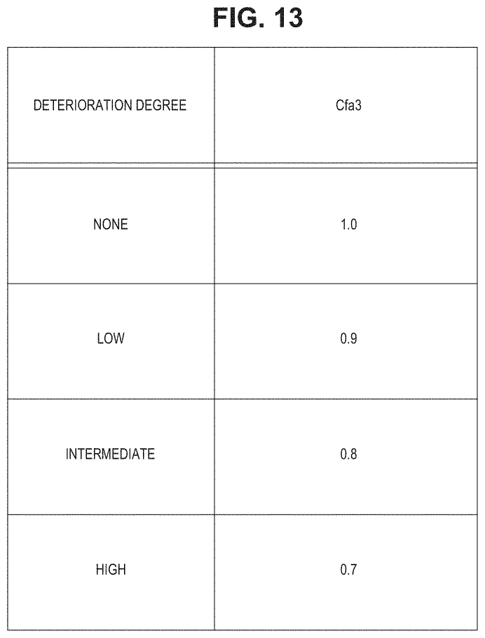

In addition to determining the coefficient Cf1 by the same method as that of the above-described embodiment, the calculation unit F120 of this modified example determines a third correction coefficient Cfa3 based on a correspondence relationship as illustrated in FIG. 13. As illustrated in FIG. 13, the third correction coefficient Cfa3 is a positive number of 1.0 or smaller, and is set such that its value becomes higher as the deterioration degree of the original painting in the part from which the topcoat painting is peeled off is lower. Classified levels of the deterioration degree and numerical values of the third correction coefficient Cfa3 illustrated in FIG. 13 are merely examples and are not limited to the examples of FIG. 13.

When the coefficient Cf1 and the third correction coefficient Cfa3 are determined by the methods as above, the calculation unit F120 calculates the incentive to be provided to the first user by multiplying the reference value Icdef of the incentive by the coefficient Cf1 and the third correction coefficient Cfa3. The value of the incentive calculated in this manner becomes higher as the first proportion is higher and as the deterioration degree of the original painting in the part from which the topcoat painting is peeled off is lower.

Flow of Processing

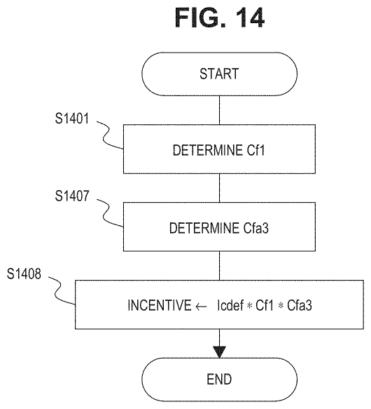

Here, a flow of processing executed in the management server apparatus 100 in this modified example will be described with reference to FIG. 14. FIG. 14 is a flowchart illustrating a subroutine that is executed instead of the above-described subroutine of FIG. 8 in the above-described step S104 in FIG. 7. In FIG. 14, processes the same as those in the above-described FIG. 8 are denoted by the same reference signs.

In FIG. 14, upon ending the execution of the process of step S1401, the calculation unit F120 executes a process of step S1407. In step S1407, the calculation unit F120 determines the third correction coefficient Cfa3. Specifically, the calculation unit F120 determines the third correction coefficient Cfa3 based on the deterioration degree of the original painting in the part from which the topcoat painting is peeled off and the above-described correspondence relationship illustrated in FIG. 13. As such, the third correction coefficient Cfa3 is determined such that its value becomes higher as the deterioration degree of the original painting in the part from which the topcoat painting is peeled off is lower. Upon ending the execution of the process of step S1407, the calculation unit F120 executes a process of step S1408.

In step S1408, the calculation unit F120 calculates the incentive to be provided to the first user by multiplying the reference value Icdef of the incentive by the coefficient Cf1 determined in step S1401 and the third correction coefficient Cfa3 determined in step S1407. In this modified example, when the first proportion is lower than 60%, the incentive calculated by the calculation unit F120 becomes “0”. On the other hand, when the first proportion is 60% or higher, the incentive calculated by the calculation unit F120 becomes higher as the first proportion is higher and the deterioration degree of the original painting in the part from which the topcoat painting is peeled off is lower. When the calculation unit F120 ends the execution of the process of step S1408, the execution of the subroutine of FIG. 14 ends.

With this modified example, the incentive to be provided to the first user who sells the first vehicle 10 becomes higher as the first proportion is higher and as the deterioration degree of the original painting in the part from which the topcoat painting is peeled off is lower. As such, it is possible to motivate the first user to peel off the topcoat painting such that the first proportion becomes even higher and to handle the first vehicle 10 such that the original painting in the part from which the topcoat painting is peeled off does not deteriorate (or to sell the first vehicle 10 before the deterioration degree of the original painting in the part from which the topcoat painting is peeled off becomes lower). As a result, the business operator who provides the services of purchasing and selling used cars can reduce costs and efforts needed to peel off the topcoat painting in the first vehicle 10 and purchase, from the first user, the first vehicle 10 in a state where the resale value thereof is even higher.

Since the deterioration degree of the original painting in the part from which the topcoat painting has been peeled off is included in the first information, the store needs to determine the deterioration degree of the original painting in the part from which the topcoat painting is peeled off. The deterioration degree of the original painting in the part from which the topcoat painting is peeled off may be determined visually and the like by the employee of the store, but may be determined using a dedicated device. For example, the deterioration degree of the original painting may be determined using a device that determines the deterioration degree of the coating by image processing using a deep learning method, a device that determines the deterioration degree of the coating by optically detecting the reflectance of the painting film, or the like.

### Modified Example 4

In the above-described modified example 1, the example where the first proportion and the length of the elapsed time since the topcoat painting has been peeled off are used as the first information is described. However, the first proportion and information on the worker who has executed the work of peeling off the topcoat painting may be used. In other words, in the above-described modified example 1, the information on the worker who has executed the work of peeling off the topcoat painting may be used instead of the length of the elapsed time since the topcoat painting has been peeled off.

Here, the original painting is less easily damaged and a peeling mark is less easily left when the person (the first worker) who provides the service of peeling off the topcoat painting as a job, such as an employee of a maintenance shop or a car dealer, peels off the topcoat painting in the first vehicle 10 than when a person (for example, the first user) other than the first worker peels off the topcoat painting in the first vehicle 10. Therefore, when it is possible to motivate the first user to request the first worker to execute the work of peeling off the topcoat painting, the business operator who provides the services of purchasing and selling used cars can reduce costs and efforts needed to remove a peeling mark and purchase, from the first user, the first vehicle 10 in the state where the resale value thereof is even higher.

Therefore, the calculation unit F120 may calculate the incentive such that the incentive to be provided to the first user becomes higher as the first proportion is higher, and the incentive to be provided to the first user becomes higher when the worker who has executed the work of peeling off the topcoat painting is the first worker than when the worker is a person other than the first worker. As such, the business operator who provides the services of purchasing and selling used cars can reduce costs and efforts needed to remove a peeling mark and purchase, from the first user, the first vehicle 10 in the state where the resale value thereof is even higher.

Since the information on the worker who has executed the work of peeling off the topcoat painting in the first vehicle 10 is included in the first information, the store needs to determine the worker. The worker may be determined based on a declaration from the first user, a declaration from the worker who has executed the work of peeling off the topcoat painting, or an image captured by a camera (for example, a camera of a drive recorder) mounted on the first vehicle 10.

### Modified Example 5

In the above-described modified example 1, the example where the first proportion and the length of the elapsed time since the topcoat painting has been peeled off are used as the first information is described. However, the first proportion and information on the method of peeling off the topcoat painting may be used. In other words, in the above-described modified example 1, the information on the method of peeling off the topcoat painting may be used instead of the length of the elapsed time since the topcoat painting has been peeled off.

Here, the original painting is less easily damaged and a peeling mark is less easily left when the topcoat painting is peeled off in the first vehicle 10 by the method (the first method) in which the original painting is not easily damaged and a peeling mark is not easily left, such as the method of spraying a high-pressure water stream on the topcoat painting, than when the topcoat painting is peeled off in the first vehicle 10 by a method (for example, a manual work) other than the first method. Therefore, when it is possible to motivate the first user to peel off the topcoat painting by the first method, the business operator who provides the services of purchasing and selling used cars can reduce costs and efforts needed to remove a peeling mark and purchase, from the first user, the first vehicle 10 in the state where the resale value thereof is even higher.

Therefore, the calculation unit F120 may calculate the incentive such that the incentive to be provided to the first user becomes higher as the first proportion is higher, and the incentive to be provided to the first user becomes higher when the method of peeling off the topcoat painting in the first vehicle 10 is the first method than when the method is a method other than the first method. As such, the business operator who provides the service for purchasing and selling used cars can reduce costs and efforts needed to remove a peeling mark and purchase, from the first user, the first vehicle 10 in the state where the resale value thereof is even higher.

Since the information on the method of peeling off the topcoat painting in the first vehicle 10 is included in the first information, the store needs to determine the method. The method may be determined based on a declaration from the first user, a declaration from the worker who has executed the work of peeling off the topcoat painting, or an image captured by a camera (for example, a camera of a drive recorder) mounted on the first vehicle 10.

### OTHERS

The above embodiment and modified examples 1 to 5 are merely examples, and the present disclosure can be appropriately modified and implemented within a range not departing from the gist thereof. For example, a part or all of the processes executed in the management server apparatus 100 may be executed in other apparatuses (for example, the store terminal 200).

Further, the processes and elements described in the present disclosure can be freely combined and executed within a range in which no technical contradiction arises. For example, the embodiment and the modified examples 1 to 5 can be executed in combination as much as possible. Further, the processes described as being executed by one device may be executed in a shared manner by a plurality of devices. Alternatively, the processes described as being executed by different devices may be executed by one device. In a computer system, the hardware configuration that implements each function can be flexibly changed.

Further, the present disclosure can also be implemented by supplying a computer with a computer program (an information processing program) that implements the functions described in the above embodiment, and by reading and executing the program by one or more processors included in the computer. Such a computer program may be provided to a computer by a non-transitory computer-readable storage medium that can be connected to a system bus of the computer, or may be provided to the computer via a network. The non-transitory computer-readable storage medium is a recording medium that can accumulate information, such as data and programs by electrical, magnetic, optical, mechanical, or chemical action, and can be read by a computer or the like. Examples of such a recording medium can include any type of disk, such as a magnetic disk (a Floppy® disk, an HDD, or the like), and an optical disk (a CD-ROM, a DVD disk, a Blu-ray disk, or the like). Further, the recording medium may be a medium, such as a ROM, a RAM, an EPROM, an EEPROM, a magnetic card, a flash memory, an optical card, or a solid state drive (SSD).

What is claimed is:

1. An information processing apparatus comprising:
a controller configured to execute processing of providing an incentive to a first user who sells or returns a first vehicle in which at least a part of a first painting film including an easily peeling layer is peeled off.

2. The information processing apparatus according to claim 1, wherein the processing of providing the incentive includes executing, by the controller, following processes:
acquiring first information on a state where the first painting film is peeled off in the first vehicle; and
calculating the incentive to be provided to the first user based on the first information.

3. The information processing apparatus according to claim 2, wherein:
the first information includes information on an area of a part from which the first painting film is peeled off in the first vehicle; and
the controller is configured to calculate the incentive such that the incentive becomes higher as the area is larger.

4. The information processing apparatus according to claim 2, wherein:
the first information includes information on a length of an elapsed time since the first painting film is peeled off; and
the controller is configured to calculate the incentive such that the incentive becomes higher as the length of the elapsed time is shorter.

5. The information processing apparatus according to claim 2, wherein:
the first information includes information on whether a peeling mark in a part from which the first painting film is peeled off is present; and
the controller is configured to calculate the incentive such that the incentive becomes higher when the peeling mark is absent than when the peeling mark is present.

6. The information processing apparatus according to claim 2, wherein:
the first information includes information on a worker who executes a work of peeling off the first painting film; and
the controller is configured to calculate the incentive according to the worker.

7. The information processing apparatus according to claim 2, wherein:
the first information includes information on a method of peeling off the first painting film; and
the controller is configured to calculate the incentive according to the method.

8. The information processing apparatus according to claim 2, wherein:
the first information includes information on a deterioration degree of an original painting in a part from which the first painting film is peeled off in the first vehicle; and
the controller is configured to calculate the incentive such that the incentive becomes higher as the deterioration degree is lower.

9. An information processing method executed by a computer, the information processing method comprising:
executing processing of providing an incentive to a first user who sells or returns a first vehicle in which at least a part of a first painting film including an easily peeling layer is peeled off.

10. The information processing method according to claim 9, wherein the processing of providing the incentive includes:
acquiring first information on a state where the first painting film is peeled off in the first vehicle; and
calculating the incentive to be provided to the first user based on the first information.

11. The information processing method according to claim 10, wherein:
the first information includes information on an area of a part from which the first painting film is peeled off in the first vehicle, and
the processing of providing the incentive includes calculating the incentive such that the incentive becomes higher as the area is larger.

12. The information processing method according to claim 10, wherein:
the first information includes information on a length of an elapsed time since the first painting film is peeled off; and
the processing of providing the incentive includes calculating the incentive such that the incentive becomes higher as the length of the elapsed time is shorter.

13. The information processing method according to claim 10, wherein:
the first information includes information on whether a peeling mark in a part from which the first painting film is peeled off is present; and
the processing of providing the incentive includes calculating the incentive such that the incentive becomes higher when the peeling mark is absent than when the peeling mark is present.

14. The information processing method according to claim 10, wherein:
the first information includes information on a worker who executes a work of peeling off the first painting film; and
the processing of providing the incentive includes calculating the incentive according to the worker.

15. The information processing method according to claim 10, wherein:
the first information includes information on a method of peeling off the first painting film; and
the processing of providing the incentive includes calculating the incentive according to the method.

16. The information processing method according to claim 10, wherein:
the first information includes information on a deterioration degree of an original painting in a part from which the first painting film is peeled off in the first vehicle; and
the processing of providing the incentive includes calculating the incentive such that the incentive becomes higher as the deterioration degree is lower.

17. A non-transitory storage medium storing instructions that are executable by a computer and that cause the computer to execute functions comprising:
executing processing of providing an incentive to a first user who sells or returns a first vehicle in which at least a part of a first painting film including an easily peeling layer is peeled off.

18. The non-transitory storage medium according to claim 17, wherein the processing of providing the incentive includes:
acquiring first information on a state where the first painting film is peeled off in the first vehicle; and
calculating the incentive to be provided to the first user based on the first information.

19. The non-transitory storage medium according to claim 18, wherein:
the first information includes information on an area of a part from which the first painting film is peeled off in the first vehicle; and
the processing of providing the incentive includes calculating the incentive such that the incentive becomes higher as the area is larger.

20. The non-transitory storage medium according to claim 18, wherein:
the first information includes information on a length of an elapsed time since the first painting film is peeled off; and
the processing of providing the incentive includes calculating the incentive such that the incentive becomes higher as the length of the elapsed time is shorter.
